(19) United States
(12) Patent Application Publication
(10) Pub. No.: US 2006/0119848 A1
(43) Pub. Date: Jun. 8, 2006

(54) Methods and apparatus for making images including depth information

(76) Inventors: John E. Wilson, Wirral (GB); Matthew G. Reed, Wirral (GB)

Correspondence Address: Roberts Abokhair & Mardula, Suite 1000, 11800 Sunrise Valley Drive, Reston, VA, 20191-5302, US

(21) Appl. No.: 10/543,183

(22) PCT Filed: Jan. 26, 2004
(86) PCT No.: PCT/GB04/00311

§ 371 Date: Aug. 22, 2005

(30) Foreign Application Priority Data
Jan. 25, 2003 (GB) 0301775.3

(51) Int. Cl. G01B 11/00

(52) U.S. Cl. 356/399

(57) ABSTRACT

A method for making an image of an object including depth information comprising the steps of: illuminating the object with a periodic pattern of light from an illuminating arrangement; the illuminating arrangement being such that the pattern is in focus in a focal plane and defocuses progressively away from said focal plane; the object being placed such that different parts of it are at different distances from the focal plane; capturing image data from the thus-illuminated object; analysing the captured image data to extract depth information based on the extent of defocussing of the pattern; and displaying an image of the object without the pattern and with depth information. Apparatus or carrying out the method, comprising an illuminating arrangement adapted to illuminate the object with a periodic pattern of light; the illuminating arrangement being such that the pattern is in focus in a focal plane and defocuses progressively away from said focal plane; the object being locatable with respect to the illuminating arrangement such that different parts of it are at different distances from the focal plane; image data capturing means adapted to capture image data from the thus illuminated object; data analysis means adapted to analyse captured image data to extract depth information based on the extent of defocussing of the pattern; and image display means for displaying an image of the object without the pattern and with depth information.

This invention relates to making images including depth information, which is to say, primarily, the production of an image of an object which includes information about the distance from the viewer of an image of parts of the imaged object.

Images including depth information include:
mask images, produced from a single viewpoint;
angular-composite images, produced from two or more viewpoints differing in angular orientation of the object about a single axis;
fully three dimensional images, produced from three or more viewpoints differing in angular orientation of the object about at least two orthogonal axes.

A three-dimensional representation of any of those images of, say, a human head, could be, for example, a sculpture, or a rendering in glass or clear plastic of the shape of the head by laser-produced point strains, visible as bright points under illumination. However, a two-dimensional representation of any of those images, for example, one displayed on a video screen, can have image depth information which can be perceived, as by manipulating the image, e.g. by rotation, or if it can be viewed by an arrangement such as a decoding screen, in the case of integral imaging, or by separating two two-dimensional images taken from adjacent vantage points, one into each eye, simulating binocular vision.

The term “depth imaging”, as used herein, means the production of an image with depth information, whether or not actually displayed, but at least with the potential of being displayed or used to produce something that can be viewed as a two-dimensional or three-dimensional representation of an object, and includes, therefore, the process of capturing information, including depth information, about the object, and the processing of that information to the point where it can be used to produce an image.

One method for depth imaging, disclosed in U.S. Pat. No. 4,657,394, involves illuminating an object with a beam of light having a sinusoidally varying intensity pattern, produced by a grating. This throws a pattern of parallel light and dark stripes on to the object. When viewed from an offset position, the stripes are deformed. A series of images is formed, using a linear array camera, as the object is rotated. Each image will be different, and from the different images, the position, in three dimensions, of each point on the surface of the object is calculated by triangulation, according to an algorithm programmed into a computer.

Other methods for depth determination using triangulation from multiple images are disclosed in DE-A-19515949, DE-A4416108, JP-A-4416108 and U.S. Pat. No. 5,085,502.

Such methods involve expensive equipment, are difficult to carry out and take a long time—usually about an hour.

The present invention provides methods that are much faster and which use less expensive equipment, and which, in particular, are capable of being used in connection with personal computers as a desktop depth imaging facility.

The invention comprises a method for making an image of an object including depth information comprising the steps of:
illuminating the object with a periodic pattern of light from an illuminating arrangement;
the illuminating arrangement being such that the pattern is in focus in a focal plane and defocuses progressively away from said focal plane;
the object being placed such that different parts of it are at different distances from the focal plane;
capturing image data from the thus-illuminated object;
analysing the captured image data to extract depth information based on the extent of defocussing of the pattern; and
   displaying an image of the object without the pattern and with depth information.

The image may be a mask image. The image data may be captured in a single image. The image may be an angular-composite image, and the data may then be captured in at least two mask images differing in the angular orientation of the object about a single axis orthogonal top a line between the object and the illuminating arrangement.

The image may be a 3D image. The image data may than be captured in at least three mask images differing in the angular orientation of the object about at least two axes orthogonal to a line joining the object and the illuminating arrangement.

The object may be placed such that it does not intersect the focal plane, and may be placed such that it is in a region in which rate of change of defocussing with distance from the illuminating arrangement is greatest, and/or a region in which the rate of change of defocussing with distance from the illuminating arrangement is reasonably constant.

The pattern may be removed from the image by capturing image data corresponding to out-of-phase light patterns on the object and image data from the object illuminated without the pattern.

The pattern may be of alternating bright and dark lines; it is desirable that no region of the pattern on the object is completely unilluminated—essentially no information can be gathered from unilluminated regions—and, of course, it is desirable that no substantial part of the object should be totally absorbing.

The pattern may be generated by a grating, which may be of equally spaced light and dark parallel lines.

The concept of projecting an image of a grating onto a 3D object to produce a composite image is known in the field of 3D measurement using structured light. Here the shape of the 3D object deforms the grating in such a way that the shape may be calculated using triangulation methods (for example—WO 00/70303). Such methods require the imaging device to be positioned at an angle to the projection device. In such measurements, the deformation of the grating makes grating removal difficult, as a loss in the periodicity of the grating has occurred. Thus depth is recovered but texture mapping requires an image without the grating present.

The projection of a grid image onto an object is known also in the art of confocal microscopy. Here the grating has only a narrow depth of focus and the presence of the grating image serves to locate the depth of those parts of the object, which lie in the same focal plane as the grating image (for example—WO 98/45745). Here the grid is removed by a phase stepping method. In brief, the technique requires at least three phase-stepped composite images and the mathematical treatment is simplified if the phase stepping is set at 120 degrees. A second example (DE 199 30 816) uses a similar phase stepping method; in this case four steps are used at 90-degree intervals. In practice it is possible to perform an approximate phase stepping method using just two steps. In this case parts of the grating image in parts of the composite image may not removed completely.

In addition to phase-stepping, correlation methods may be used to subtract a grating image from a composite image. The use of correlation functions in the statistical analysis of signals and images is widespread. The exact nature of the correlation analysis is dependant on the image data available, in particular:
1. knowledge of the form of the grating image, e.g. sine wave
2. knowledge of the period and amplitude of the grating image
3. knowledge of the position of the fuiction in the composite image
4. knowledge of the wide field image, i.e. image in the absence of the grating

Where both grating and wide field images are known, the grating may be removed completely and depth information may be gained at the pixel level. Where less information is available, it may be necessary to recover depth and texture information at the period level.

The extent of defocussing may be calculated on the basis of the width of a line of the pattern or on the basis of the modulation contrast of the pattern.

The frequency response of a defocused optical system was first described by H. H. Hopkins (Proc. Roy. Soc. A 231, 3,1955). Here a description is given of the defocus function and its dependence on the image and optical properties. In brief, the distribution of intensity in the image plane is found by integrating the intensity distributions in the diffraction images associated with each point in the object. For a simple object (a lined grating) the defocus function (D) (also termed the optical transfer function and the modular transform function) may be calculated analytically and is often expressed in terms of a universal frequency function (s). By definition, ‘s’ is inversely proportional to the aperture of the lens and proportional to the spacing of the grating. In practice this is seen as fine structure exhibiting only a short depth of focus whereas small apertures give a large depth of focus.

With knowledge of the basic optical parameters, D(s) versus s may be plotted for individual optical systems. The function is seen to display a largely linear region between the values 0.8 and 0.2. This is advantageous when depth distance is to be calculated from the defocus function.

A further description of the defocus function is given by P. A. Stokseth (J. Opt. Soc. Am. 59#10, 1314 1969). Here the defocus function is calculated analytically using both diffraction and geometrical optics theories. In addition, an empirical treatise is given. The defocus function is shown to asymmetrical either side of the focal plane (sphere), with a longer depth of defocus being observed behind the plane of focus.

The image may be scanned over parallel scan lines, parallel to or angled with respect to the lines of the pattern; the parallel scan lines may be at right angles to the lines of the pattern.

The mask image data may comprise pixel image data, which may be analysed on a pixel by pixel basis.

Image capture may be by a line scan camera or by an area scan camera, and may be in monochrome or colour. The captured image data may be analysed to calculate colour information from the brightest parts of the image, namely from the brightness peaks of the pattern.

Calculated depth information may be adjusted using a calibration, as by a calibration look-up table, which may be generated by comparing calculated with actual depth measurements on a specimen object.

The image may be formatted for display using any preferred display system, such, for example, as a video screen driven by software simulating and manipulating 3D images, or as an integral or multiview image which can be viewed using a decoding screen.

The invention also comprises imaging apparatus for making an image of an object including depth information, comprising:
an illuminating arrangement adapted to illuminate the object with a periodic pattern of light;
the illuminating arrangement being such that the pattern is in focus in a focal plane and defocuses progressively away from said focal plane;
the object being locatable with respect to the illuminating arrangement such that different parts of it are at different distances from the focal plane;
image data capturing means adapted to capture image data from the thus illuminated object;
depth analysis means adapted to analyse captured image data to extract depth information based on the extent of defocussing of the pattern; and
image display means for displaying an image of the object without the pattern and with depth information.

The image data capturing means may capture a mask image, and may comprise a one-dimensional or a two-dimensional array of detectors. Such may comprise a monochrome or colour CCD or CMOS camera.

The illuminating arrangement may comprise a light source, focussing means and a grating.

The light source may comprise a source of incoherent light, such as an incandescent filament lamp, a quartz-halogen lamp, a fluorescent lamp or a light-emitting diode. The light source may, however, be a source of coherent light, such as a laser.

The focussing means may comprise a lens or a mirror, and may comprise a cylindrical, spherical or parabolic focussing arrangement.

The imaging apparatus may comprise a support for an object to be imaged. The support may also support the illuminating arrangement in such relationship that the object is supported so that the focal plane does not intersect the object, and desirably in a region in which the rate of change of defocussing with distance from the illuminating arrangement is reasonably constant.

The support may also permit relative adjustment between the object and the illuminating arrangement, and may comprise a turntable.

The apparatus may also comprise means adapted to vary the periodic pattern of light, which may comprise means adapted to alter the orientation of a grating producing a periodic pattern of light.

The image display means may comprise a video screen driven by software capable of simulating and manipulating a 3D image.

Embodiments of imaging apparatus and methods of imaging according to the invention will now be described with reference to the accompanying drawings, in which:

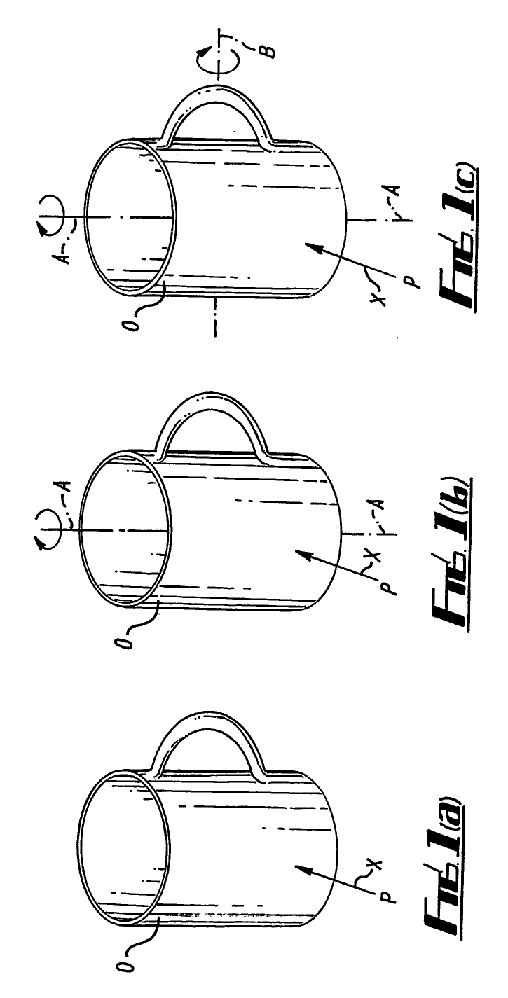

FIG. 1 shows (a) a mask image view of an object O from a single viewpoint; (b) a peripheral view such as will, when integrated, give rise to an angular-composite image; and (c) a fully three-dimensional view in which the object is rotated with respect to the viewer about two orthogonal axes;

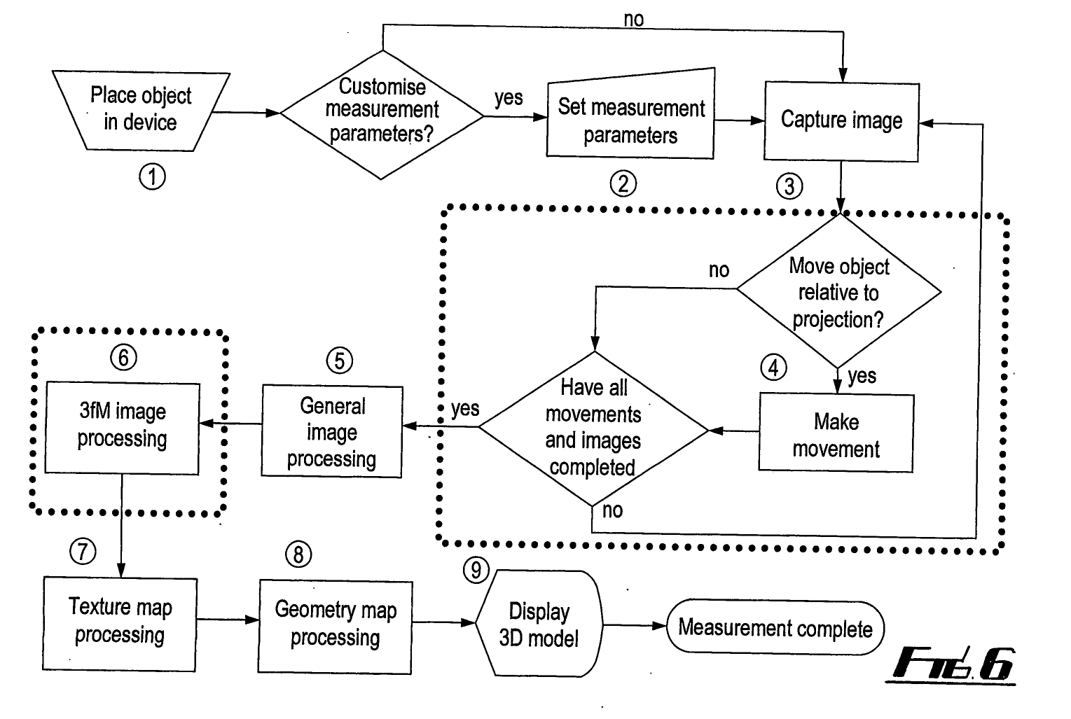

FIG. 2 illustrates the underlying principle of progressive defocussing with depth;

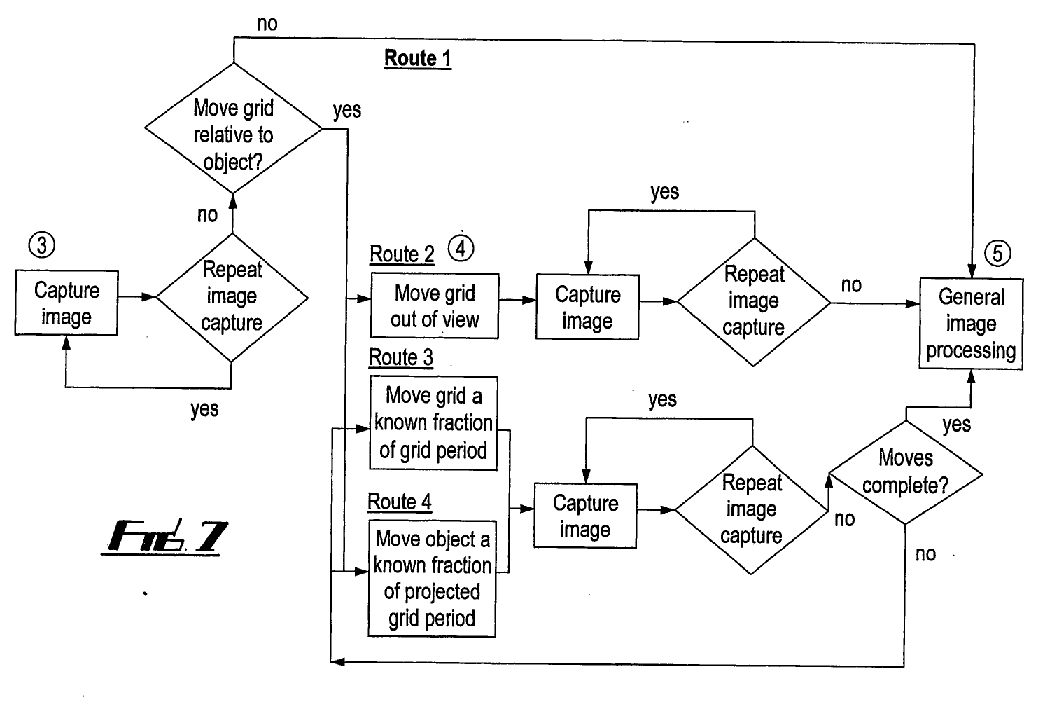

FIG. 3 is a view of a first embodiment of apparatus, for mask or angular-composite imaging;

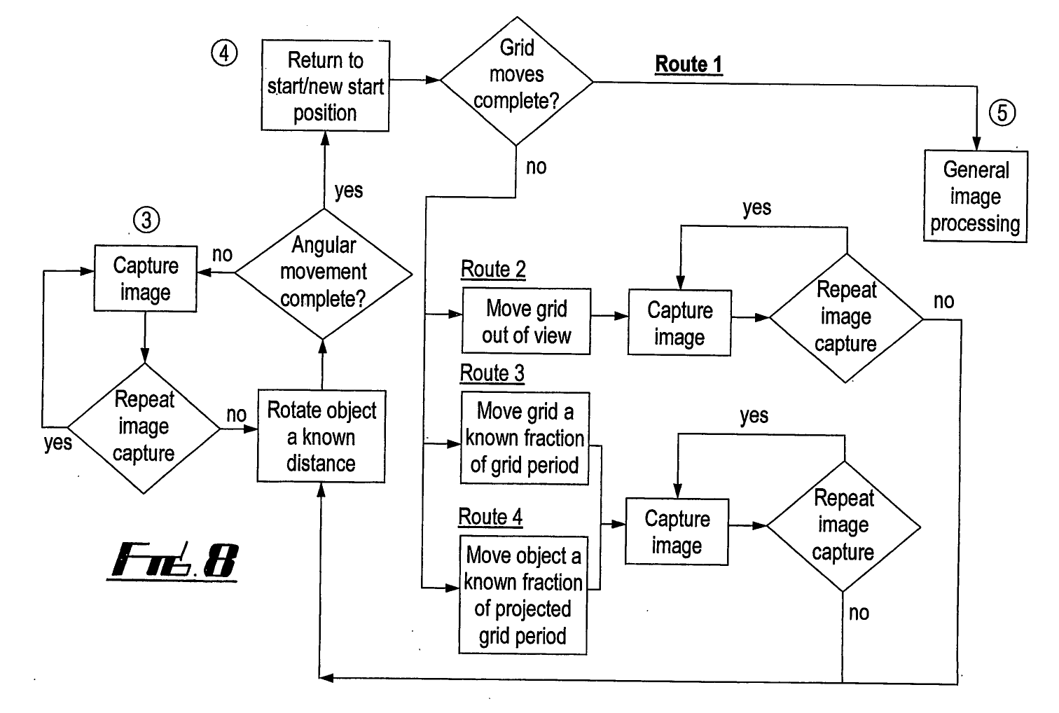

FIG. 4 is a view of a second embodiment of apparatus, for fully three-dimensional imaging

FIG. 5 illustrates four embodiments (a)-(d) of an illuminating arrangement;

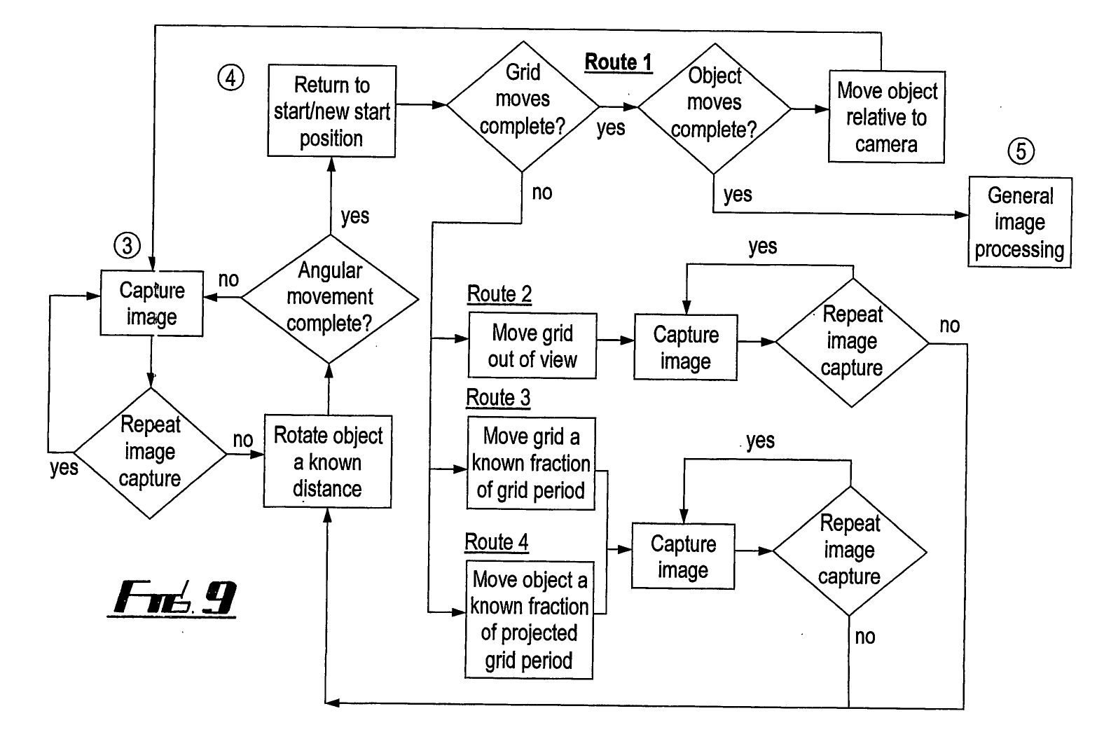

FIG. 6 is a flow diagram showing an overview of the imaging method;

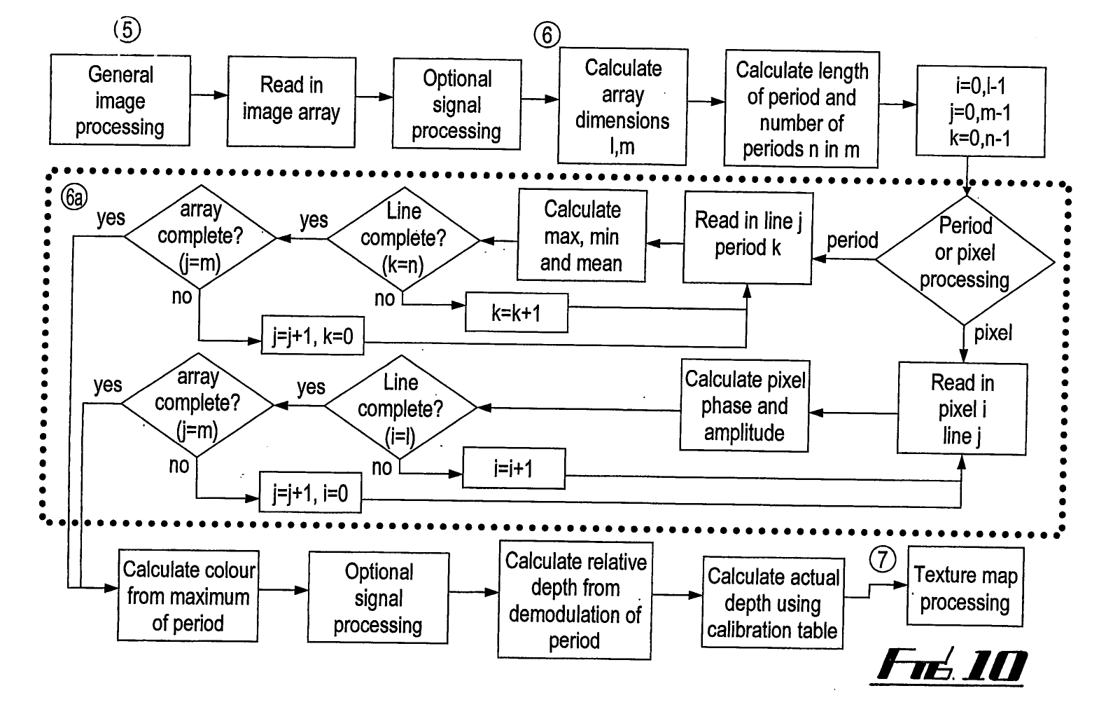

FIG. 7 is a flow diagram showing in detail one embodiment of one step in the flow diagram of FIG. 7;

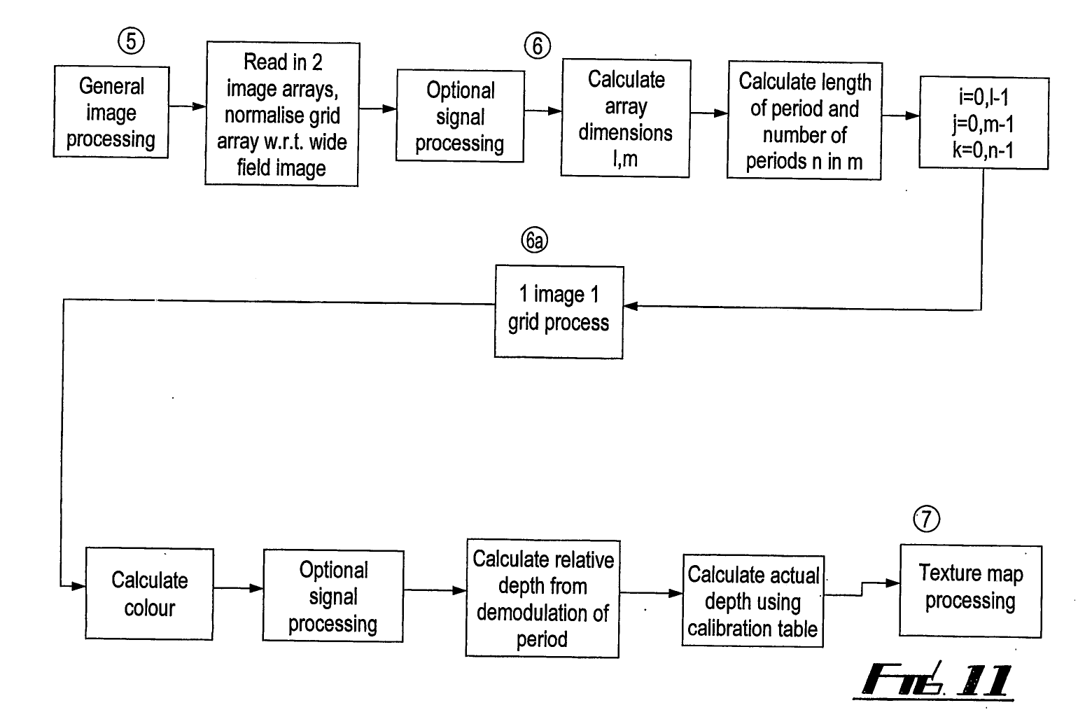

FIG. 8 is a flow diagram showing in detail another embodiment of the step of FIG. 8;

FIG. 9 is a flow diagram showing in detail yet another embodiment of the step of FIG. 8;

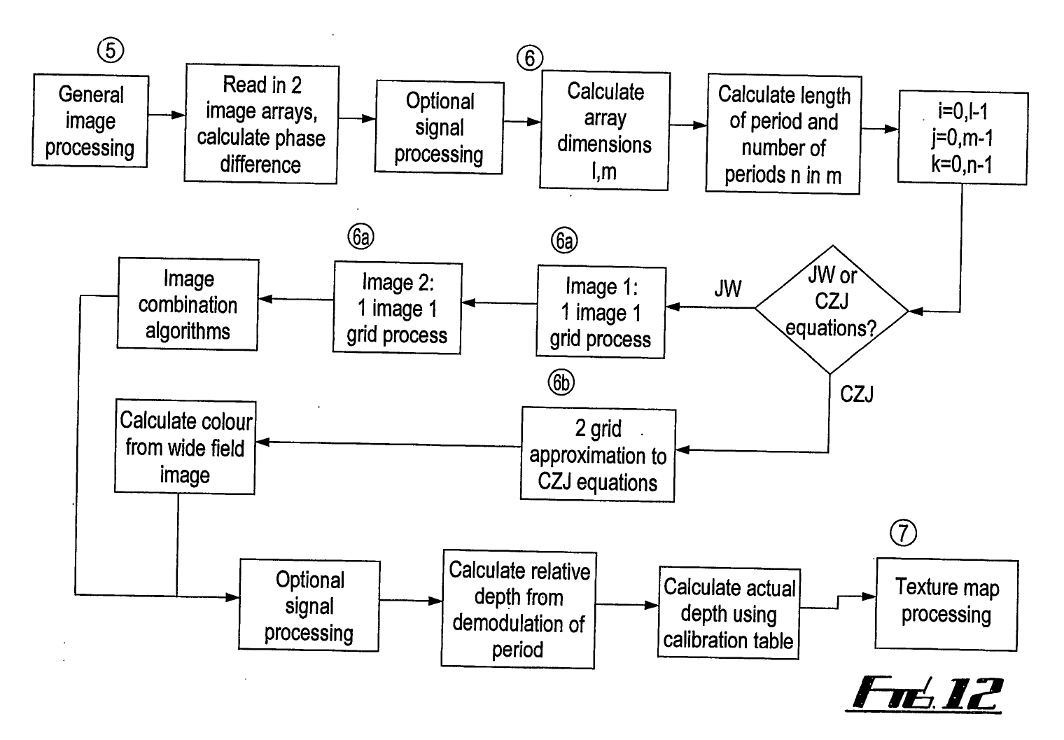

FIG. 10 is a flow diagram showing in detail one embodiment of another step in the flow diagram of FIG. 7;

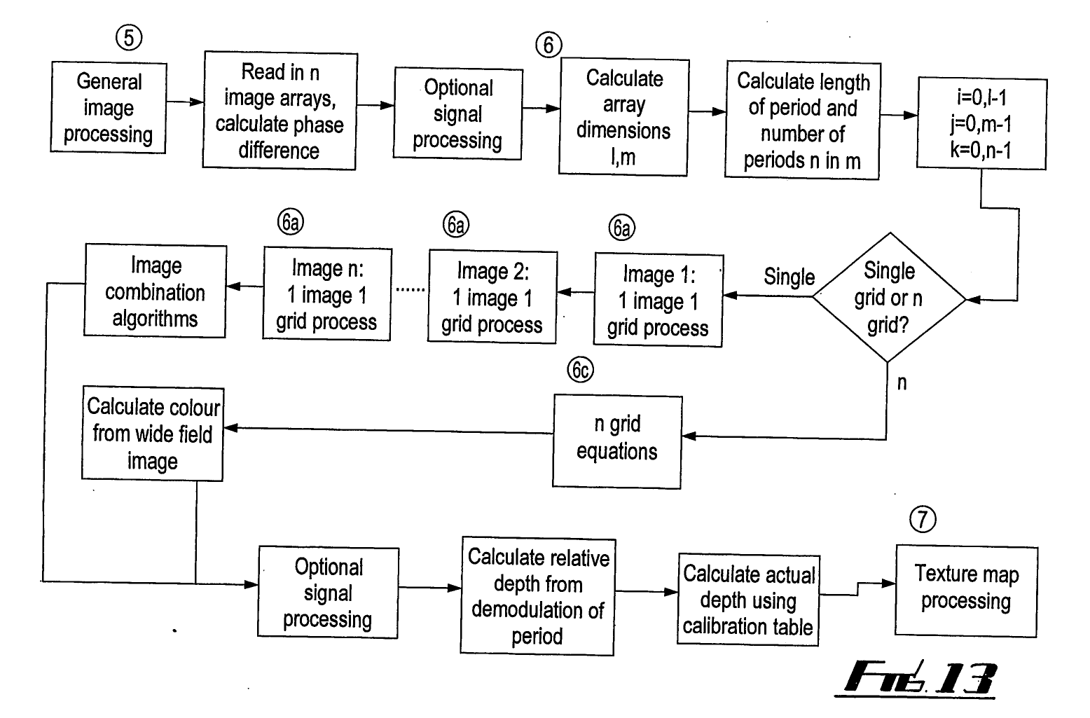

FIG. 11 is a flow diagram showing in detail another embodiment of the step of FIG. 11;

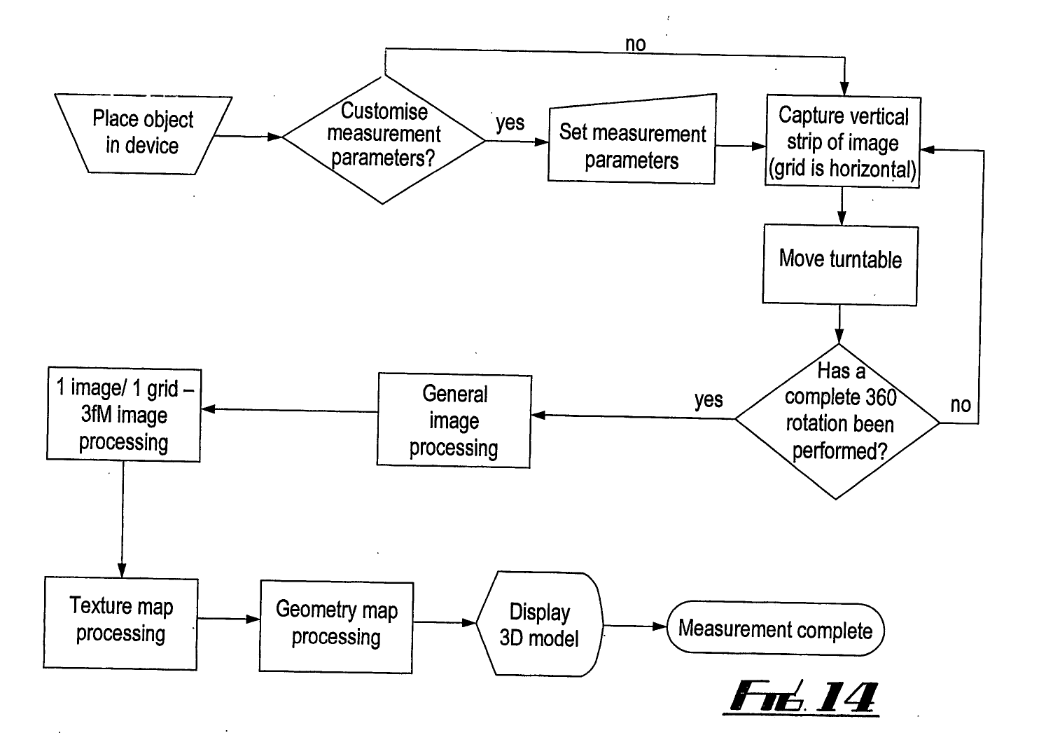

FIG. 12 is a flow diagram showing in detail yet another embodiment of the step of FIG. 11;

FIG. 13 is a flow diagram showing a generalisation of the detail of FIG. 13;

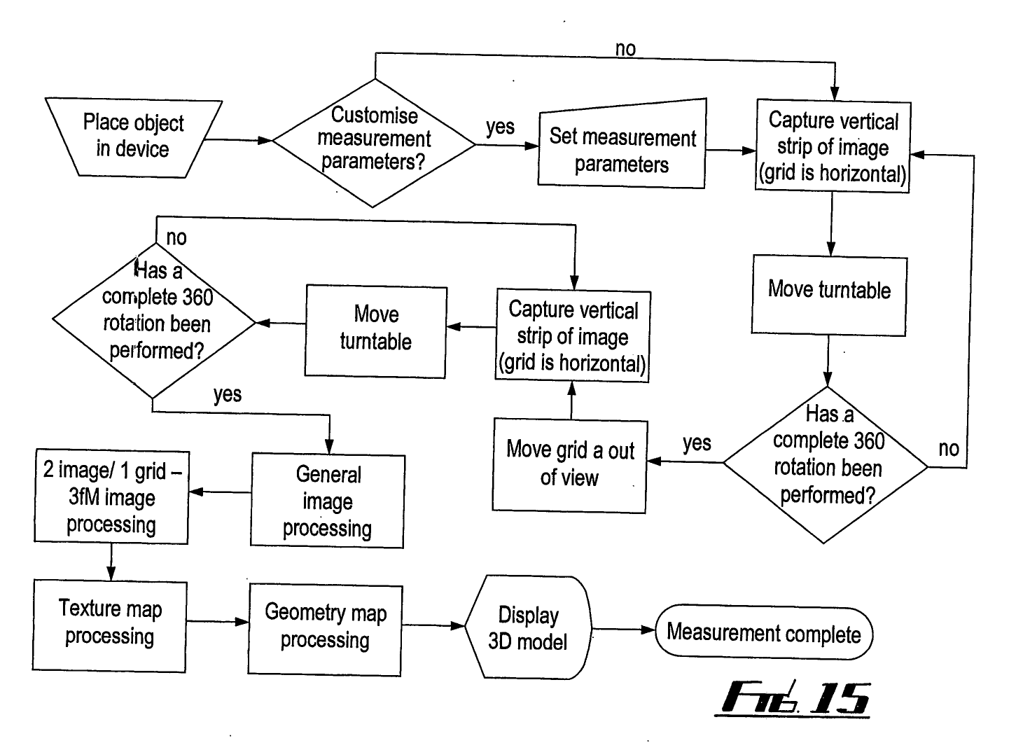

FIG. 14 is a flow diagram showing one complete measurement method:

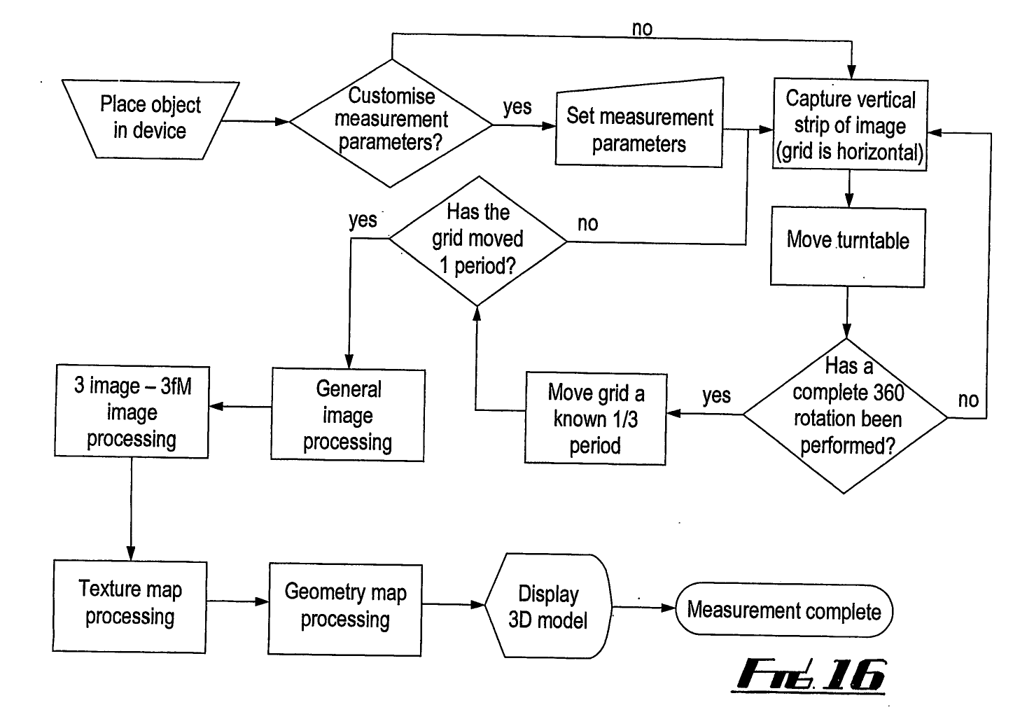

FIG. 15 is a flow diagram showing another complete measurement method;

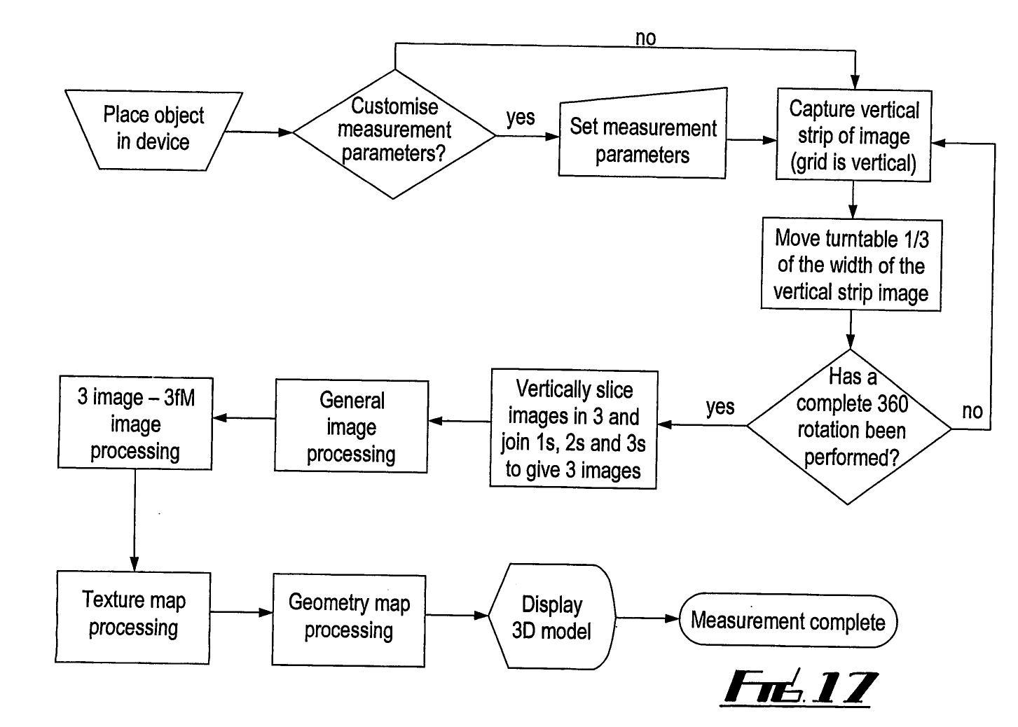

FIG. 16 is a flow diagram showing another complete measurement method; and

FIG. 17 is a flow diagram showing a fourth complete measurement method.

The drawings illustrate an imaging apparatus for making an image of an object O including depth information, comprising:
an illuminating arrangement 11 adapted to illuminate the object O with a periodic pattern 12 of light;
the illuminating arrangement 11 being such that the pattern 12 is in focus in a focal plane 13 and defocuses progressively away from said focal plane 13;
the object O being locatable with respect to the illuminating arrangement 11 such that different parts of it are at different distances from the focal plane 13;
image data capturing means 14 adapted to capture image data from the thus illuminated object 11;
depth analysis means 15 adapted to analyse captured image data to extract depth information based on the extent of defocussing of the pattern 12; and
image display means 16 for displaying an image 17 of the object O without the pattern 13 and with depth information.

FIG. 1 illustrates three different methods of imaging that can yield depth information about an object O. In FIG. 1(a), the object is viewed from a single viewpoint. This is not usually conducive to capturing depth information, but, using the present invention, depth information can be extracted from such a view. An image thus formed is termed a mask image. In FIG. 1(b), the object O is viewed from more than one viewpoint. In human binocular vision, and in binocular or multiview photography, depth information is gleaned from differences in the images. In integral imaging, a single viewpoint is apparently used, but a wide ‘taking’ aperture and integral optics afford many different viewpoints within the taking aperture. While such measures will serve to give depth information which can make an image appear to be three-dimensional, this will only apply to such regions of the object as are visible from the viewing position or positions. In order to acquire information about the back of the object, it is necessary to view from at least two, preferably more different directions. Such an image taken from two or more viewpoints as the object is rotated relatively to a single taking position is termed an angular-composite image.

If the top and bottom of the object are to be imaged, it is necessary to have further viewpoints, with the object rotated, relative to the taking position, about two axes A, B each orthogonal to a line X joining the object O and the viewing position P, as shown in FIG. 1(c). An image incorporating such information can be termed a fully three dimensional image.

By and large, objects stand on the ground or a base, and so an underview is unnecessary, and sufficient information can be gleaned from an angular-composite image, which corresponds to human binocular vision, but which can contain more information if the back of the object is taken into account.

Using methods as herein described, simple mask images, angular-composite images and fully three dimensional images can be made, each with depth information sufficient to produce a final image with the appearance of depth.

FIG. 2 illustrates the underlying principle. A light source L casts a pattern of light and dark lines from a grating M1 by means of a lens F1. The pattern is in focus at a focal position f distant d from the lens F1. Were the pattern to be cast on a screen closer than the distance d, the pattern would be out of focus, and is shown diagrammatically as being more out of focus the closer the screen approaches the lens F1. Contrast between the light and dark lines of the pattern is greatest at the focal distance d, and falls off towards the lens F1. The measured modulation depth of the pattern gives an indication of the distance of the screen from the focal position f.

If, instead of a flat screen, the pattern falls on a shaped object, the pattern will be more or less out of focus at different positions on the object, and the modulation depth would be correspondingly different. The distance of each point of the object from the focal position can be calculated as a function of the measured modulation depth at that point. This will be termed “structured modulation imaging” (SMI).

The method differs from triangulation methods, in that imaging and viewing can take place from a single position, and the pattern defocuses over the depth of the object, whereas in triangulation, sharp focus over the whole object is preferred.

The modulation depth as a function of distance from a focal plane of a lens system is discussed in WO-A-98/45745 and DE 199 30 816 A1.

In those publications, which are concerned with microscopy, it is taught that the grid may be displaced so that the pattern moves into discrete positions across the object displaced by fractions of the grating constant, and an image of the pattern's projection on the object is recorded for each position of the grating. Only the in-focus parts of each image are used; they are assembled into a single image. The modulation depth information is used to remove the pattern from the image mathematically.

In contrast, the method according to the invention is concerned with macroscopic imaging, and does not depend on such displacement of the grid.

The method comprises the steps of:
illuminating the object O with a periodic pattern 12 of light from an illuminating arrangement 11;
the illuminating arrangement 11 being such that the pattern 12 is in focus in a focal plane 13 and defocuses progressively away from said focal plane 13;
the object O being placed such that different parts of it are at different distances from the focal plane 13;
capturing image data from the thus-illuminated object O;
analysing the captured image data to extract depth information based on the extent of defocussing of the pattern 12; and
displaying an image 17 of the object without the pattern 12 and with depth information.

The image may be a mask image, in which the captured image data are captured in a single image, or it may be an angular-composite image, in which the image data are captured in at least two mask images differing in the angular orientation of the object O about a single axis orthogonal to a line between the object O and the illuminating arrangement 11. Or the image may be a 3D image, in which the image data are captured in at least three mask images differing in the angular orientation of the object about at least two axes orthogonal to a line joining the object O and the illuminating arrangement 11.

The method will be described in these three aspects with reference to the flow diagrams of FIGS. 6 to 17, and FIGS. 3, 4 and 5.

FIG. 3 shows apparatus for carrying out mask or angular-composite imaging, comprising an illuminating arrangement 11, and a turntable 31 on which the object O is placed. The turntable 31 is rotated by an electric motor 32 about an axis 33 which is orthogonal to the optical axis 34 of the illuminating arrangement 11. The motor 32 is controlled by a computer 35 to rotate the turntable stepwise through selected angular amounts.

FIG. 4 shows apparatus for carrying out fully three-dimensional imaging, as well, of course, as mask and angular-composite imaging. Similar to the embodiment of FIG. 3, it has, however, a support 41 on the turntable supporting the object O on an axis 42 about which it can be rotated by a second electric motor 43, also controlled by the computer 35, also in desired angular steps.

In the apparatus of both FIG. 3 and FIG. 4 is an image capture arrangement 36, that may comprise an area scan or a line scan digital camera arrangement. A keyboard 37 is used tro input instructions into the computer 35, and a VDU 38 displays the image.

FIG. 5 shows four different embodiments of the illuminating arrangement 11.

FIG. 5(a) shows a light source L such as an incandescent filament lamp, illuminating a parallel line grating M1 with a focussing arrangement F1, such as a convex lens forming a virtual image of the grating in a focal plane P. The grating M1 can be mounted on a carriage (not shown), which would also be controlled by the computer 35 of FIG. 3 or 4, to move in the direction of Arrow A perpendicular to the rulings of the grating M1.

FIG. 5(b) shows a slit D interposed between the grating M1 and focussing means F1 of FIG. 5(a). The grating M1 can be moved, again by the carriage, not shown, angularly with respect to the slit D and also perpendicularly to the lines of the grating M1, Arrows B and A. These movements alter the spatial frequency of the illumination pattern, allowing altered modulation contrast characteristics for a fixed focussing means F1.

FIG. 5(c) shows a helical grating M3 and a slit D placed between the light source L and the focussing means F1. The light source L here can be a fluorescent tube. Rotation of the helical grating about its axis moves the pattern projected on the object O.

FIG. 5(d) shows a collimated, controlled intensity light source L projecting on to a scanning mirror 51 which, at any one position, projects a strip of illumination on to the object O. If the intensity of the light source is synchronised with the scan, any desired light intensity pattern can be displayed on the object O.

FIG. 6 is a flow diagram generic to all methods for forming and displaying images with depth information.

To begin the process at Step 1, the object O is placed in the apparatus, on the turntable 31, and illuminated with whichever pattern is desired for the image in question.

The object can be of any shape, size (so long as it fits into the apparatus) and colour, the only limitation being that it must reflect light at least to some extent, so it cannot be black or totally absorbing over its entire surface. It should also preferably not be totally transparent. Objects with black regions or of glass or transparent plastics materials will give poor depth resolution. Objects up to 150 mm long can be imaged in an apparatus with a paper size A4 footprint, which will conveniently fit on a desktop.

The software provides at Step 2 an option to customise the measurement parameters and set the customised parameters before capturing the image in the camera 35. Such customisation can include selection of:
colour, monochrome or sepia
grid defocus over radius or diameter of turntable
grid frequency
lamp intensity
colour and polarising filters
camera lens aperture setting
automatic gain control (AGC) on camera
gamma setting on camera
brightness on camera
contrast on camera
use of RBG channels separately or combined in depth calculation
number of pixels, horizontal and vertical, used on camera
number of steps per rotation (for angular-composite and 3D images)
number of rotations of turntable
number of steps per period, i.e. how many grids are to be used in the algorithm
grid divergence corrections
averaging algorithms, and at which stage in the calculations they are used
smoothing algorithms, and at which stage in the calculations they are used
texture map algorithm
geometry transformation algorithm
3D viewer

After the image is captured at Step 3, it is subjected, at Step 5, to general image processing, involving, for example, the use of smoothing algorithms and cut and reassembly operations.

The processed image is then further processed at Step 6 to extract the depth information. This will be dealt with in detail below.

The image information yielded by Step 6 is then further processed at Step 7 to add colour and or texture, as will, again, be further discussed below.

At Step 8, geometrical mapping is performed, which might involve changing the coordinate system from Cartesian coordinates, in which the initial measurement might have been made, to cylindrical coordinates, in which the final image might be displayed.

Finally, at Step 9, the image is displayed on whatever display arrangement has been selected to display it. This might be a computer monitor screen, which will, of course, display only a 2D image, but such image can be manipulated by rotating it, for example, to show it from different aspects, and even show the back of the imaged object. Or it might be a monitor screen with a decoding screen, the image on the screen having been processed into the format of an integral image such that, viewed through the decoding screen, the image appears to have depth appropriate to binocular vision. Or the image information might be used to generate a true 3D set of coordinates used to drive a laser to write a 3D image in a glass or transparent plastic block.

In Step 4, as seen in FIG. 6, the object is moved, unless a single mask image is to be made. The movement will be, in the case of an angular-composite image, a rotation about the axis 33 of the turntable. In this case, the illumination, and the image, will be of a vertical strip, as seen in FIG. 5(d), and the turntable will be stepped around so that the entire object (or so much of it as may be desired to image) is imaged in vertical strips. Such strips are ‘welded’ together in the general image processing step, Step 5. If fully 3D image is required, the rotation about the axis 42 of the turntable 31 is also effected.

Possibly, the object O is first imaged as an angular-composite image when it is the right way up, then it is flipped through 90° about axis 42 and another set of images made.

FIG. 7 is a sub-flow diagram of the operation of making a mask image, i.e. one made as from a single viewpoint without rotation of the object. The whole of the object area facing the imaging apparatus is illuminated with the pattern.

There are four possible routes through this sub-flow diagram.

Route 1 is the simplest. First, the image is captured—this may be repeated one or more times, to gain better resolution from averaging multiple images. The single, or single averaged image is then sent straight to step 5 for general image processing. The image will, of course, contain depth information, in the form of the extent of defocussing of the pattern at different locations on the image, manifest as modulation contrast. In the subsequent image processing, this information is extracted and the pattern removed by appropriate algorithms.

On Route 2, a first image is made with the grid pattern in place, than a second image is made with the grid moved out of the way. Both first and second images, of course, may be made more than once and averaged. Both images are sent for further processing, depth information being extracted from the first image, and transferred to the second image, which does not, of course, have the pattern, so there is now no need of a pattern removal operation.

On Route 3, the grid, on Route 4, the object (which amounts to the same thing) is moved a known fraction of a grid period, and a second image taken. These two images are then sent for processing to extract depth information and remove the pattern for the final image processing steps.

FIG. 8 is a sub-flow diagram for Step 4 for an angular-composite image. A first image is captured, and, if desired, as before, one or more repeat captures made. The object is rotated a known angular extent, and another image is made. This is repeated until the whole object, or such part of it as is required, has been imaged in vertical strips, as explained above. A composite image is built up from the multiple strip images at the general image processing step, Step 5. In this operation, the pattern may be shifted, either to take it away completely, or to move it, or the object, a fraction of a grid period, as before, for each strip image.

FIG. 9 is a sub-flow diagram for Step 4 for a fully three-dimensional imaging operation. The procedure is as in Step 4 for the angular-composite image, with the additional step of moving the object relatively to the camera, about the other axis, axis 42.

FIG. 10 is a sub-flow diagram for Step 6 for the single image, single grid method, Route 1 of sub-flow diagram, FIG. 6. The single image is taken from the general image processing step, Step 5 and the pixel brightness values read into an image array, on which further signal processing may be carried out if desired. The array dimensions are calculated and the length and number of periods of the pattern are calculated. The processing may be carried out on a period or pixel basis. On a period basis, the maximum, minimum and mean pixel brightness values are calculated for each period in each line of the array. In pixel based processing, the pixel phase and amplitude are calculated for each line of the array. Colour is derived from the maximum of the period signal, i.e. where the colour is not affected by the grid pattern. The relative depth of each image portion is calculated from the modulation contrast derived from either of the previous calculations. The actual depth is then calculated from a look up table obtained in a calibration step, which is simply an imaging operation as just described, compared with actual measurements of the distance of various portions of a test object from the imaging lens.

Where more than one image, and/or more than one grid position are involved, these calculations are made for each image and grid position, as will be seen from the sub flow diagrams for Step 6 as shown in FIGS. 11, 12 and 13. FIG. 13 has an option to use single grid or n grid depth extraction algorithms.

FIGS. 14, 15, 16 and 17 are flow charts for exemplary imaging methods selected from the more generalised flow charts of the preceding figures.

Many variations are possible within the context of the invention. Different methods may be used for illuminating the object, including filament lamps, fluorescent lamps, lasers and so on. It is possible to use single wavelength light, or even infrared or ultraviolet light, if colour is not required, and appropriate imaging devices are used. Instead of a ‘mechanical’ grating, an electronic grating can be used, which can be controlled as to frequency and position. And different arrangements may be used for displaying and manipulating the final image, including a laser writing arrangement to a glass or plastic block or a computer assisted manufacturing arrangement which may involve spark erosion or other shaping technology, for rapid prototyping.

1-57. (canceled)

58. A method for making an image of an object comprising including depth information comprising:
illuminating the object with a periodic pattern of light, whereby the pattern is in focus in a focal plane and progressively defocused as distance from the focal plane changes;
capturing image data from the illuminated object;
analysing the extent of defocussing of the pattern in the captured image data;
extracting depth information based upon the extent of the defocusing; and
displaying an image of the object without the pattern and with the depth information.

59. A method according to claim 58, in which the image is a mask image.

60. A method according to claim 59, in which the captured image data are captured in a single image.

61. A method according to claim 58, in which the image is an angular-composite image.

62. A method according to claim 61 wherein capturing image data from the illuminated object comprises capturing image data in at least two mask images from differing angular orientations about a single axis orthogonal to a line between the object and the illuminating source.

63. A method according to claim 58, wherein capturing image data comprises capturing 3D image data.

64. A method according to claim 63, wherein capturing 3D image data comprises capturing the 3D image data in at least three mask images from differing angular orientation about the object in at least two axes orthogonal to a line joining the object and the illuminating source.

65. A method according to claim 58 wherein the object does not intersect the focal plane.

66. A method according to claim 58 wherein illuminating the object with a periodic pattern of light comprises illuminating with alternating bright and dark lines.

67. A method according to claim 58 wherein illuminating the object with a periodic pattern of light comprises illuminating with a grating.

68. A method according to claim 67, in which the grating is of equally spaced light and dark parallel lines.

69. A method according to claim 58 analysing the extent of defocussing of the pattern comprises calculating the extent of defocussing based on the modulation contrast of the pattern.

70. A method according to claim 59 wherein the mask image data comprise pixel image data.

71. A method according to claim 70, wherein analysing the extent of defocussing of the pattern comprises analyzing the pixel image data on a pixel-by-pixel basis.

72. A method according to claim 58, wherein capturing image data comprises capturing the image data in colour.

73. A method according to claim 58 wherein displaying an image of the object comprises formatting the image data for display using a preferred display system.

74. An Imaging apparatus for making an image of an object comprising depth information, comprising:
an illuminating apparatus adapted to illuminate the object with a periodic pattern of light;
the illuminating apparatus configured such that the periodic pattern is in focus in a focal plane and defocused progressively as distance from the focal plane changes;
an image data capturing means adapted to capture image data from the thus illuminated object;
data analysis means adapted to analyse captured image data and to extract depth information based on the extent of defocussing of the pattern; and
image display means for displaying an image of the object without the pattern and with depth information.

75. Apparatus according to claim 74, wherein the illuminating apparatus comprises a light source, focussing means and a grating.

76. Apparatus according to claim 75, further comprising a support, the support adapted to support the illumination apparatus and the object in relationship to one another such that the object does not intersect the focal plane.

77. Apparatus according to claim 76, wherein the support permits relative adjustment between the object and the illuminating apparatus.

78. Apparatus according to claim 76 wherein the support comprises a turntable.

79. Apparatus according to claim 75, further comprising means adapted to alter the orientation of the grating.

80. Apparatus according to claim 74 wherein the image display means comprises a video screen driven by software capable of simulating and manipulating a 3D image.
